(19) United States
(12) Patent Application Publication
(10) Pub. No.: US 2001/0035877 A1
(43) Pub. Date: Nov. 1, 2001

(54) Content-dependent display components

(76) Inventor: Robert T. Killian, Dallas, TX (US)

Correspondence Address: TEXAS INSTRUMENTS INCORPORATED, P O BOX 655474, M/S 3999, DALLAS, TX, 75265

(21) Appl. No.: 09/842,996

(22) Filed: Apr. 26, 2001

Related U.S. Application Data
(60) Provisional application No. 60/206,781, filed on May 24, 2000.

(51) Int. Cl. G06F 3/00; G06F 13/00

(52) U.S. Cl. 345/744; 345/760

(57) ABSTRACT

A system for providing data/information from a service provider at a display when requested includes providing from the service provider data/information and a displaylet in a communications data packet when requested by a user at a display device such as at a settop box and TV set. The displaylet contains a display program and data for controlling the manner in which the display is presented. The display can be a video or audio presentation or both. The displaylet is self contained with a header, processing rules, the type and name of the program locator and the data for the presentation which may be video, audio, sound, text, graphics, etc.

### FIELD OF INVENTION

This invention relates to display components (graphical user interfaces), and more particularly to content-dependent display components.

### BACKGROUND OF INVENTION

User interfaces (a.k.a. visual interfaces, graphical user interfaces, etc.) typically implement a single paradigm and look-and-feel for arranging and presenting data information to the user. Even with interfaces whose configurability permit selection of multiple display paradigms and/or looks-and-feels, only one is active at a time. With such interface-dependent displays, the data/information content provider must have either previously agreed to some generic display of their data, or are indifferent to how their data is presented. Either way, data/information content providers are forced to settle for displays they have little or no control over and may not effectively convey the message and/or experience desired.

Making modifications to interface-dependent displays is problematic also. When a change is made, every user machine must be updated with the new display method. Some users may update soon, some later, and some never. This will lead to content which will display differently on different machines, or perhaps not at all on some machines.

### SUMMARY OF INVENTION

In accordance with one embodiment of the present data elements, i.e., displaylets, are created that contain instructions for how data/information content is to be displayed. Displaylets also include media (sound, images, video, graphics, text, etc.) required by the intended display. Displaylets can be co-located with the content and transmitted along with the content to the machine or device where the user interface is running. A user interface receives the displaylet along with the content and utilizes the instructions and media within the displaylet for presentation of the content.

### DESCRIPTION OF THE DRAWINGS

FIG. 1 illustrates displaylets and a system for sending the displaylets;

FIG. 2 illustrates a displaylet packet;

FIG. 3 illustrates a displaylet system according to one embodiment of the present invention;

FIG. 4 illustrates a system using displaylets according to a second embodiment of the present invention; and

FIG. 5 illustrates a system using displaylets according to a third embodiment of the present invention.

### DESCRIPTION OF PREFERRED EMBODIMENTS OF THE PRESENT INVENTION

The present inventions can be used in many applications. One application is an electronic program guide where the user either by subscription or otherwise receives a television listing information similar to a “TV Guide” for present day and future programs. The data or information of times is transmitted via wireless or wired or cable means to a TV step-top box or built into a television. The data/information is sent by various ways to the user. In accordance with the present invention in addition to the data/information there is provided a separate displaylet containing a separate program and data for a display for displaying the data/information such as the listing information for the electronic program guide example.

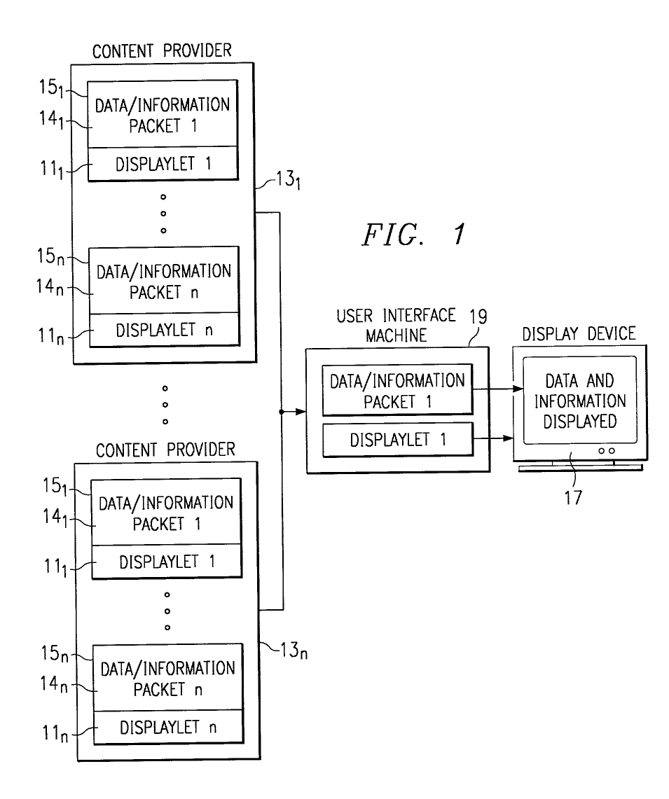

Referring to FIG. 1, displaylets 11 may originate from one or more content providers or sources 13₁ through 13ₙ. For the electronic program guide example, the content provider may be a network such ABC or CBS. Each content provider 13₁-13ₙ may potentially have several “packets” 15₁-15ₙ of content to transmit to an end user device 17. The displaylet 11₁-11ₙ is co-located with the data/information 14₁-14ₙ in the packets 15₁-15ₙ and transmitted therewith to the machine the user interface is running. An example of this scenario would be where the user interface machine 19 is a client such as a TV set top box which allows a user to query a database server for data/information to be displayed on the client's display device (TV) 17. In this case, the database server would be one of the content providers 13₁-13ₙ and the user interface machine 19 would be the client. In the electronic program guide example the data/information 14 is the program listing information and the displaylet would be the media components such as sound, images, graphics, video, text, etc. that the network wanted displayed with the information. It may be as simple as a CBS logo at a particular area on the screen to an elaborate video display and sound presentation to go with the listing.

Each transmission of content with the data information packet 15 to the client would contain a displaylet 11 that specifies the characteristic look-and-feel intended for that content. The client 19 would receive the requested content, detect and extract the associated displaylet 11, then use the displaylet 11 to present the content to the user on the client's display device 17.

Typical solutions to date have used interface-based approaches to the problem which involve implementing different looks-and-feels on the user interface machine and allowing the user to configure which the interface uses when data/information is displayed. This gives the user some degree of content display control but not the content provider or the owner of the content. Once a look-and-feel is selected, that same look-and-feel is used for display of all subsequently received content regardless of its source. Also, there is no guarantee that different users will configure the same look-and-feel on their machine. Therefore, the same content will be displayed differently to users on different machines.

Instead of the interface-based approach typically used, displaylets 11 are a content-based approach. The look-and-feel of the content's presentation is itself determined by the contents. So, in a sense, the displaylet 11 is part of the contents. This permits each content presented by the content provider 13₁-13ₙ to be customized according to the displaylet 11₁-11ₘ associated with it. Also, since the content provider 13₁-13ₙ provides the displaylet 11, this gives the content provider control over how their data/information is displayed to the user. The CBS network for example can control what is displayed when a given program listing is displayed.

Since displaylets 11 are created by content providers and transmitted along with the content to the user interface machines 19, users see the new displays instantly without having to perform any upgrades. Also, since displaylets 11 are content-dependent, each user will see the same display as every other user for any given content.

In accordance with the present invention, the displaylets are created data elements that contain instructions for how data/information content is to be displayed. The displaylets also include any media components (sound, images, video, graphics, text, etc.) required by the intended display. The displaylets are preferably co-located with the content and transmitted along with the content to the machine or device where the user interface is running. As illustrated above, the user interface receives the displaylet along with the content and utilizes the instructions and media within the displaylet for presentation of the content.

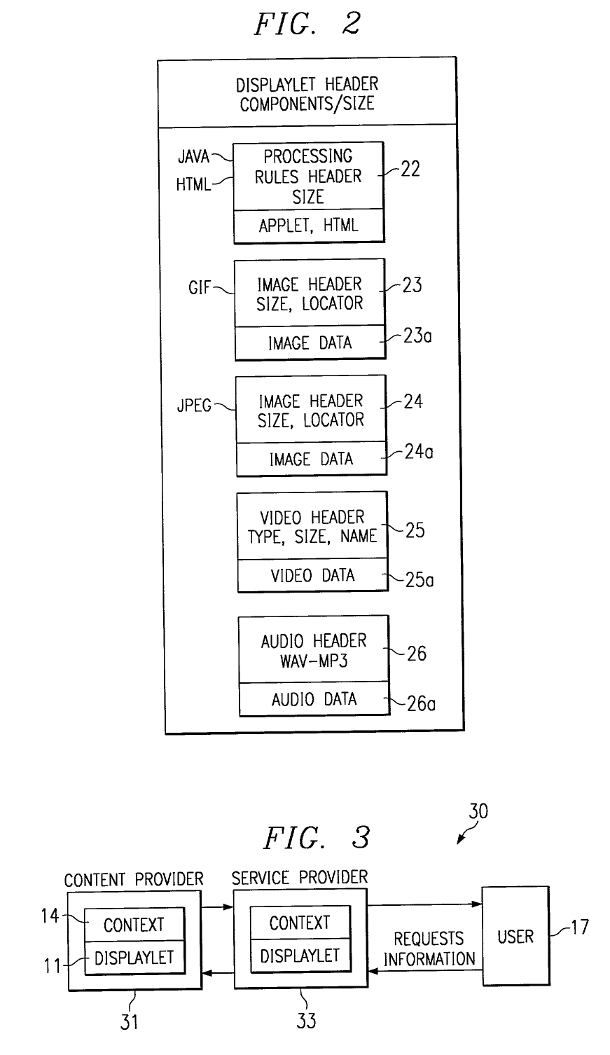

The displaylet 11 as illustrated in FIG. 2 provides the applications program for running the display and the data. The displaylet includes a header 21 with components/size; processing rules 22 such as HTML or JAVA Applets and/or JAVA Script; image header 23 with type such as Graphics Interchange Format GIF) with size and component locator and image data 23a or image header 24 with Joint Photographic Experts Group (JPEG) file type with size and name or other component locator and the image data 24a; video header 25 with file type such as MPEG or Audio Video Interleave (AVI) for video clips and data 25a and audio header 26 with file type such as WAV or MP3 and data 26a.

A displaylet packaging tool organizes displaylet component, builds displaylet structures, add all component headers and saves the packaged displaylet. The processing rules organize component on screen and controls the color, font, position and size of the component. The rules determine the displays of the inactive elements such as menus, text box, sizes, scroll bars and buttons.

Referring to FIG. 3, there is illustrated a first system 30 where the content provider 31 generates the displaylet 11 and the data/information and transmits this combination in a packet via a service provider 33 such as TCI cable, AT&T, a satellite provider) to a user device 17. The content provider 31 provides the displaylet to the user device when requested by the user.

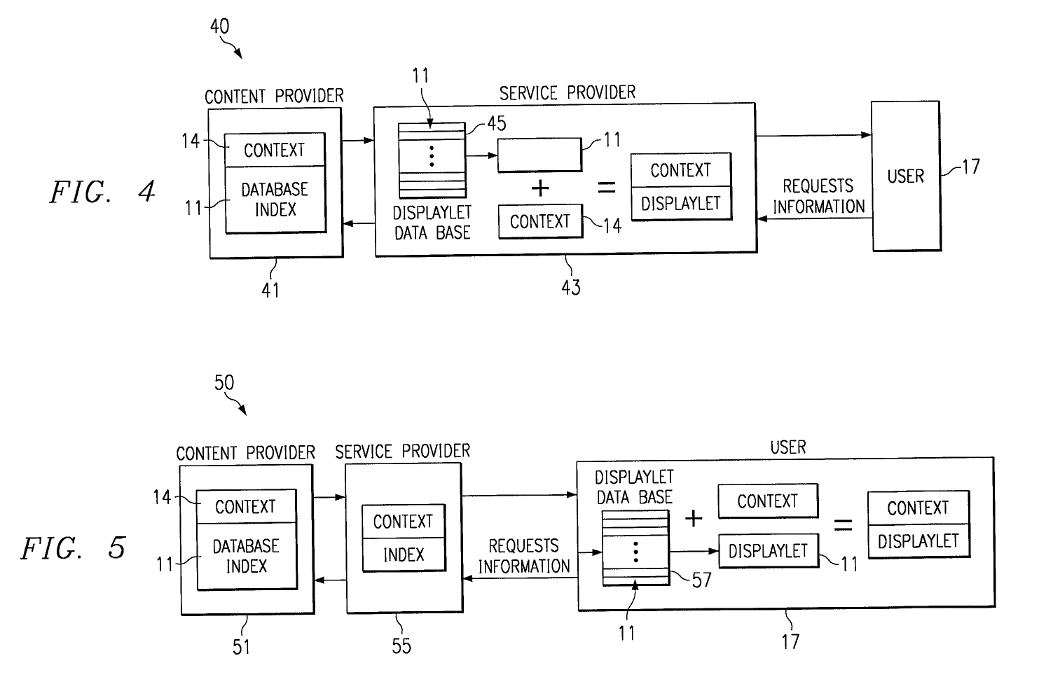

Referring to FIG. 4, there is illustrated a system 40 wherein the service provider 43 contains indexed displaylets 45 and the content provider 41 provides a displaylet index address 47 to the service provider 43 wherein the service provider extracts the displaylet 11 and adds the displaylet 11 to the data/information 14 and transmits the combination to the user device 17 when user requests the information.

In accordance with the system 50 of the present invention as disclosed in FIG. 5, the indexed displaylet database 57 is at the user device 17 location and the content provider 51 generates and provides the index to the user upon request via the service provider 55. At the user device 17 the indexed displaylets are addressed by the address sent from the content provider 51 and the displaylet is added to the data/information and the combination is displayed.

What is claimed:

1. A system for providing data and displaying information from a content provider to a user comprising:
a user display;
a user interface machine;
and means responsive to a user request from the user interface machine for generating a content provider packet containing data/information and a displaylet to said user interface machine and displaying it on said user display;
said displaylet comprising display program and display data for controlling the way the data is displayed at the user display.

2. The system of claim 1 wherein said content provider generates the data/information and generates a displaylet to provide to the user when requested by the user.

3. The system of claim 2 wherein said packet containing data/information and displaylet is provided via a service provider.

4. A system for providing data and separate display information comprising:
a user interface machine;
a user display;
means for generating at a content provider a packet containing data/information and a displaylet, said display comprising a display program and data for controlling the manner in which the data/information is displayed;
means for transmitting said packet from said content provider via a service provider when to said interface machine and display when requested by the user.

5. The system of claim 4 wherein said displaylet contains media component information and said interface machine generates video and audio at said display.

6. A system for providing data/information and separate display information comprising:
a user interface machine;
a user display coupled to said interface machine;
a content provider for providing data/information to the interface machine and display and a service provider when requested by a user at said interface display machine;
a service provider including indexed displaylets to be run on said interface machine;
said content provider providing an index address to said service provider in response to said request from said user whereby said displaylet addressed is provided to said user interface machine from said service provider, said displaylet comprising a display program and data for controlling how said data/information is presented.

7. A system for providing data and separate display information comprising:
a user interface machine;
a user display coupled to said interface machine;
a content provider for providing data/information and a displaylet address to the interface machine when requested by said user at said interface machine;
said interface machine containing displaylets indexed by said content provider displaylet address for displaying or otherwise presenting the data/information according to the displaylet program and data.

8. The system of claim 1 wherein said displaylet containing a header, processing rules, an image header with file type and name or other component locator and image data.

9. The system of claim 8 wherein said displaylet rules organize components on the screen and controls the color, font, position and size of the component.

10. The system of claim 8 wherein the displaylet rules determine the display of the interactive elements including menus, text boxes, sizes, scroll bars and buttons.

11. The system of claim 8 including a video header with file type and name or locator and image data.

12. The system of claim 8 including an audio header and audio data.
